(19) United States
(12) Patent Application Publication
(10) Pub. No.: US 2024/0378368 A1
(43) Pub. Date: Nov. 14, 2024

(54) WEB FONT SERVICE METHOD OF FONT SERVICE SYSTEM

(71) Applicant: SANDOLL INC., Seoul (KR)

(72) Inventors: Young Ho Yun, Seoul (KR); Hyun Jin Yun, Seoul (KR); Dong Hyuk Park, Seoul (KR)

(73) Assignee: SANDOLL INC., Seoul (KR)

(21) Appl. No.: 18/688,152

(22) PCT Filed: Feb. 14, 2023
(86) PCT No.: PCT/KR2023/002121

§ 371 Date: Feb. 29, 2024

(30) Foreign Application Priority Data
Mar. 7, 2022 (KR) 10-2022-0028798

(51) Int. Cl. G06F 40/109; G06F 40/154

(52) U.S. Cl. CPC G06F 40/109; G06F 40/154

(57) ABSTRACT

Disclosed herein is a web font service method of a font service system. The web font service method of a font server may include receiving web font request information from a client provided with website information including an HTML tag for executing a web font module and transmitting web font information to the client based on the web font request information, wherein the web font module generates cascading style sheet (CSS) information including location information of a web font based on text information obtained by collecting texts on a web page of a website for each font and adds the CSS information to the website information, and the client transmits web font request information generated by recognizing the generated CSS information to a font server.

### TECHNICAL FIELD

The present invention relates to a web font service method of a font service system that provides web fonts according to web font requests.

### BACKGROUND ART

Web fonts are technology for using font files to express text on websites. As platforms for accessing websites, such as mobile phones and tablets, become more diverse, the use of web fonts has increased. Therefore, it is more important to quickly render a web font on a web page of a website.

In this regard, in the case of a conventional web font-related art (1. A web font transmission system generated with a character combination requested by a client, and a web font transmission method using the same (patent application number 10-2013-0060836), for rendering a web page of one website, cascading style sheet (CSS) information is requested by a font server and received, based on which a web font is requested again (sequentially requested twice).

This method of requesting twice of the prior art for web font information is a factor that slows down a rendering speed of web pages, and if the rendering speed of web fonts slows down, various problems may occur.

For example, when the rendering speed of a web font is slow, a flash of invisible text (FOIT) and a flash of unstyled text (FOUT) may occur, which may cause inconvenience to customers using websites.

Therefore, there is a need for a web font service method that may improve the rendering speed of websites.

### DISCLOSURE

### Technical Problem

An object of the present invention is to provide a web font service method of providing web fonts according to web font requests.

More specifically, an object of the present invention is to propose a web font service method of improving a rendering speed of a website by minimizing time consumption due to the use of web fonts.

### Technical Solution

According to an exemplary embodiment of the present invention, a web font service method of a font server may include: receiving web font request information from a client provided with website information including an HTML tag for executing a web font module; and transmitting web font information to the client based on the web font request information, wherein the web font module generates cascading style sheet (CSS) information including location information of a web font based on text information obtained by collecting texts on a web page of the website for each font and adds the CSS information to the website information, and the client transmits web font request information generated by recognizing the generated CSS information to a font server.

The web font service method may further comprising: performing, by the font server, a web font service authentication procedure using e received web font request information and pre-stored user authentication information.

In the adding to the website information, a duplicate text among the collected may be removed and the texts may be sorted and de-identified in Unicode order to generate de-identified text information for each font.

In the adding to the website information, when a length of a text among the collected texts exceeds a predetermined length, the corresponding text may be divided to generate text information for each unit font.

In the adding to the website information, it may be determined whether there is a text corresponding to a replacement font among the collected texts, and when text corresponding to the replacement font is included, the text corresponding to the replacement font may be separated to generate text information for each font.

The web font service method may further comprising: receiving, by the font server, service usage information for using the web font service from a customer; obtaining a web font based on the service usage information; generating a web font module dedicated to the customer based on the obtained web font; and generating an HTML tag for executing the web font module and providing the HTML tag to the customer.

The transmitting of the web font information to the client may include generating a font subset based on the web font request information and transmitting web font information including the generated font subset to the client.

According to another exemplary embodiment of the present invention, a web font service method of a web server may include: receiving a website access request from a client; and providing website information including an HTML tag for executing a web font module to the client, wherein the web font module generates cascading style sheet (CSS) information including location information of a web font based on text information obtained by collecting texts on a web page of a website for each font and adds the CSS information to the website information, and the client transmits web font request information generated by recognizing the generated CSS information to a font server.

The web font service method may further comprising: transmitting service usage information for using a web font service to a font server; and receiving an HTML tag for executing a web font module generated based on the web font service usage information.

According to another exemplary embodiment of the present invention, a font service system of providing a web font service may include: a client configured to access a website and request web font information necessary for the website; a web server configured to provide website information to the client requesting access to the website; and a font server configured to provide web font information to the client, wherein, when requesting access to a website, the web server provides website information including a HTML tag for executing a web font module to the client, the web font module generates cascading style sheet (CSS) information including location information of a web font based on text information obtained by collecting texts on a web page of a website for each font and adds the CSS information to the website information, the client transmits web font request information generated by recognizing the generated CSS information to a font server, and the font server generates web font information based on the web font request information and transmits the web font information to the client.

According to another exemplary embodiment of the present invention, a computer-readable recording medium in which a program of performing the web font service method described above is stored may be implemented.

### Advantageous Effects

According to the present invention, by using a web font module that collects text on a website by font to generate text information, generates cascading style sheet (CSS) information based on the generated text information, and inserts the CSS information into an HTML document, time consumption due to the use of web fonts when rendering a web page may be minimized.

In addition, the present invention has the effect of reducing the capacity of web fonts, shortening a download time of web fonts, and reducing network traffic and costs by using an optimized web font subset when providing web font information.

In addition, the present invention has the effect of easily replacing missing glyphs of a specific font or mixing it with other fonts to make specific letters stand out by using the web font module to which a replacement font is applied.

### DESCRIPTION OF DRAWINGS

FIG. 1 is a diagram illustrating a font service system according to an embodiment of the present invention.

FIG. 2 is a conceptual diagram illustrating a service usage information registration process for using a web font service according to an embodiment of the present invention.

FIG. 3 is a timing diagram illustrating a service usage information registration process for using a web font service according to an embodiment of the present invention.

FIG. 4 is a diagram illustrating replacement font information according to an embodiment of the present invention.

FIG. 5 is an example diagram illustrating an HTML tag for executing a web font module according to an embodiment of the present invention.

FIG. 6 is a conceptual diagram illustrating a web font service method according to an embodiment of the present invention.

FIG. 7 is a timing diagram illustrating a web font service method according to an embodiment of the present invention.

FIG. 8 is a diagram illustrating a web page screen according to an embodiment of the present invention.

FIG. 9 is a conceptual diagram illustrating a font service usage information registration process according to another embodiment of the present invention.

FIG. 10 is a timing diagram illustrating a font service usage information registration process according to another embodiment of the present invention.

FIG. 11 is a conceptual diagram illustrating a method of providing a font service according to another embodiment of the present invention.

FIG. 12 is a timing diagram illustrating a method of providing a font service according to another embodiment of the present invention.

### BEST MODE

The following description illustrates only a principle of the present invention. Therefore, those skilled in the art may implement the principle of the present invention and invent various apparatuses included in the spirit and scope of the present invention although not clearly described or illustrated in the present specification. In addition, it is to be understood that all conditional terms and exemplary embodiments mentioned in the present specification are obviously intended only to allow those skilled in the art to understand a concept of the present invention in principle, and the present invention is not limited to exemplary embodiments and states particularly mentioned as such.

The above-mentioned objects, features, and advantages will become more obvious from the following detailed description associated with the accompanying drawings. Therefore, those skilled in the art to which the present invention pertains may easily practice a technical idea of the present invention.

Further, in describing the present invention, in the case in which it is decided that a detailed description of a well-known technology associated with the present invention may unnecessarily make the gist of the present invention unclear, it will be omitted. Hereinafter, various exemplary embodiments of the present invention will be described in detail with reference to the accompanying drawings.

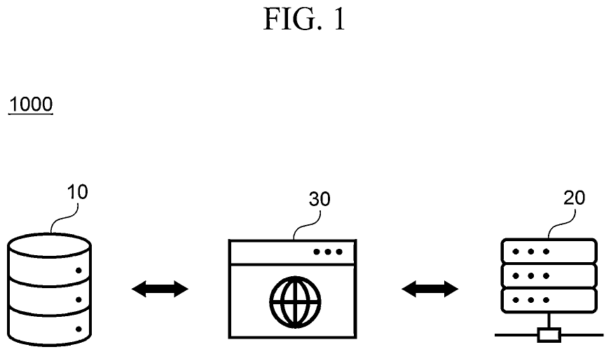

FIG. 1 is a diagram illustrating a font service system according to an embodiment of the present invention.

Referring to FIG. 1, a font service system 1000 may include a font server 10, a web server 20, and a client 30.

The font server 10 may generate and store various font files and font subsets and provide various font information to those requesting fonts.

Specifically, the font server 10 may provide web font information according to a web font request from the client 30 and perform a web font service authentication procedure, a web font service registration procedure, etc. In addition, the font server 10 may generate a customer-specific web font module based on web fonts.

The web server 20 is a server for providing web services to users and may provide website information to the client 30 requesting access to the website.

The client 30 may be a concept that includes a web browser that accesses a website and requests web font information required for the website, or a web view that renders HTML (HyperText Markup Language). For example, the client 30 may be a web browser, such as Safari, Chrome, Edge, Internet Explorer, Firefox, etc. used in smartphones, computers, laptops, and tablets. Alternatively, the client 30 may include an application that operates in conjunction with a network in an operating system, such as Android or iOS.

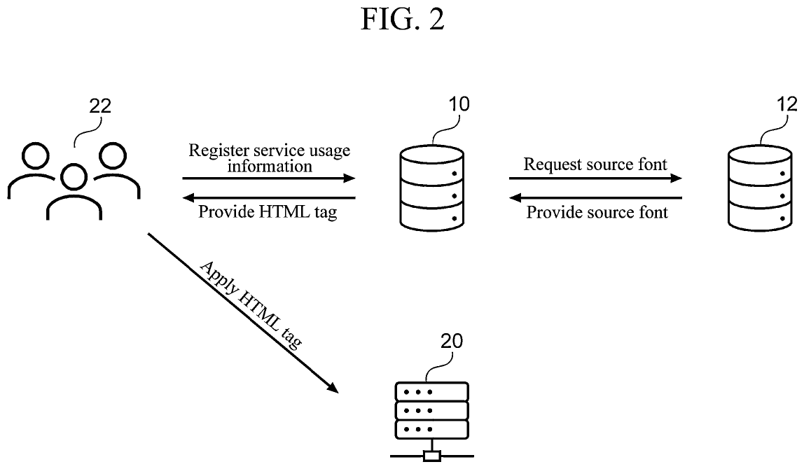

Hereinafter, a process of registering service usage information for using a web font service will be described with reference to FIG. 2.

FIG. 2 is a conceptual diagram illustrating a service usage information registration process for using a web font service according to an embodiment of the present invention.

Referring to FIG. 2, customers 22 may transmit web font service usage information to the font server 10 in order to use the web font service, and the font server 10 may register the corresponding customer based on the web font service usage information. Here, the customer 22 may be a user who wants to apply a web font to the web server 20 and may refer to a font purchaser.

In addition, the font server 10 may check a font list in the font server 10 to determine whether a web font to be used by the customer 22 exists based on the service usage information, and if the font does not exist, the font server may request a source web font corresponding to the font from a source font server 12 and be provided with the source web font.

In addition, the font server 10 may generate and store a web font module dedicated to the customer 22 based on the web font and generate and store user authentication information for user authentication.

Then, the font server 10 may generate an HTML tag for executing the web font module and provide the HTML tag to the customer 22, and the customer 22 may use the web font service by applying the corresponding HTML tag to a website in the web server 20 of his/her own.

Meanwhile, in FIG. 2, the font server 10 and the source font server 12 are described as separate components, but the configuration of the font server 10 and the source font server 12 is not limited thereto. For example, the source font server 12 may exist as a database of the font server 10.

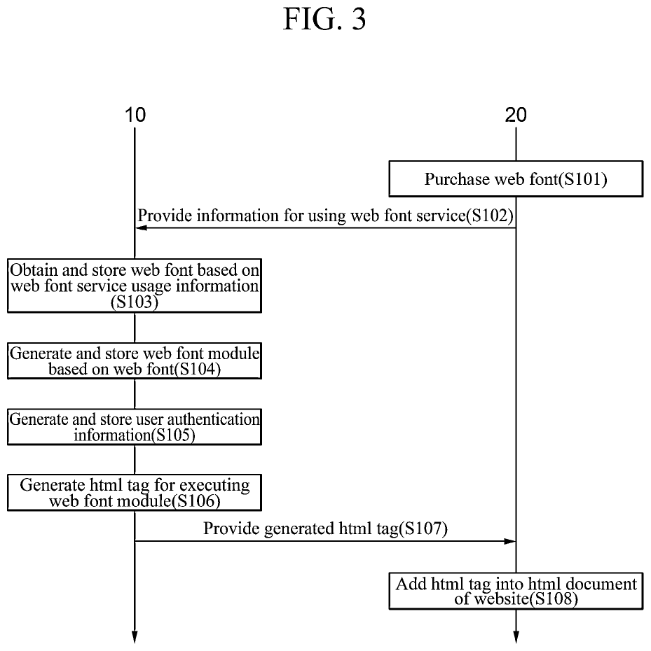

Next, the service usage information registration process described above will be described in more detail with reference to FIG. 3.

FIG. 3 is a timing diagram illustrating a service usage information registration process according to an embodiment of the present invention.

In FIG. 3, in order to increase convenience of description, a process of transmitting and receiving information between the font servers 10, based on the web server 20 operated by the customer 22 is described.

Referring to FIG. 3, the web server 20 may purchase a web font to be used on a website from the font server 10 (S101). For example, the web server 20 may purchase each web font individually at a predetermined price or purchase a voucher that may be used for a predetermined period of time at a predetermined price. Alternatively, it is also possible to purchase a subscription type that allows to freely use a specific set of web fonts.

A method of purchasing web fonts is not limited to the above-mentioned example and may be purchased and used in various manners depending on the sales method of the font server 10.

Next, the web server 20 may provide information for using the web font service to the font server 10 (S102). Specifically, the web server 20 may provide service usage information for using the web font service to the font server 10. Here, the service usage information may include at least one of the list of fonts to be used in the web server 20, a customer name, a product name of a font to be purchased, a service use period, an application domain, and a test IP.

Furthermore, in the present embodiment, the range of languages or formats supported by the web server 20 may be different due to the nature of the font, so it is also possible to request a service for characters in a language or format that is not supported in the text with a replacement font of another similar type.

Accordingly, the web server 20 may provide service usage information that additionally includes replacement font information to the font server 10. Specifically, the replacement font is a font used to replace characters not included in a specific font with another font to be displayed on a screen, which may be used when intentionally replacing some characters with another font, and the replacement font information may include at least one of a start position, an end position, and a type of replacement font.

For example, replacement font information may be used in a case in which the Korean font does not contain a Chinese character glyph and needs to be replaced with another font, or a case in which English letters are intentionally replaced with a unique font and displayed to intentionally make them stand out, in a case in which numbers (U+0030 to U+0039 area)) are replaced with a specific font, in a case in which English capital letters (U+0041˜U+005A area) are replaced with a specific font, a case in which Chinese characters (U+4E00˜U+9FFF area) with a specific font, and a case in which ASCII codes (U+0200 to U+007E area) are replaced with a specific font. At this time, because an area designation within the replacement font information uses Unicode, the area may be freely specified for all Unicode text.

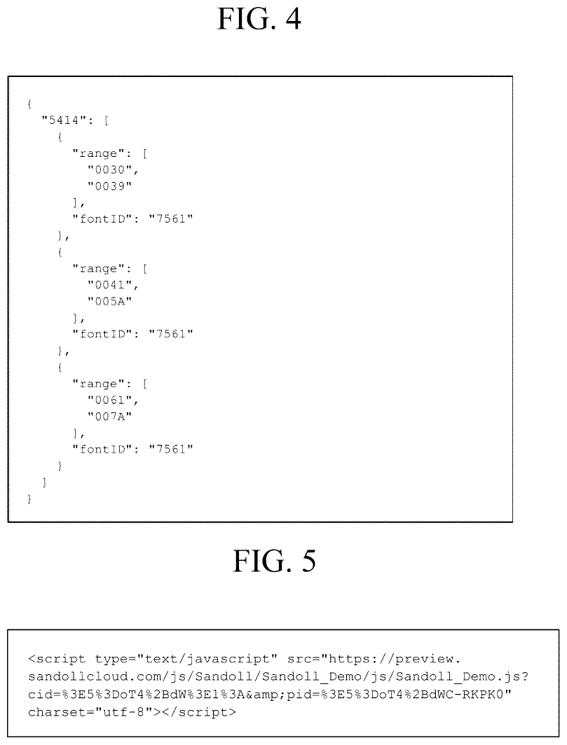

Specifically, the replacement font information may be in the form of a {replacement target font ID: [{“range”: [start position, end position], “fontID”: replacement font ID}, {“range”: . . . } . . . ]}, replacement target font ID: ID of a target font to be replaced, Unicode range: Unicode range of a letter to be replaced, [start Unicode, end Unicode] form, number [0030, 0039], English uppercase letters [0041, 005A], English lowercase letters [0061, 007A] replacement font ID (fontID): ID of font to be replaced. For example, the replacement font information may have the form shown in FIG. 4.

Furthermore, in the present embodiment, it is also possible to extract a replacement font based on the similarity of a vector by using a feature vector of a font list requested as a condition for selecting a replacement font. In addition, replacement fonts may be set separately by Unicode range.

Specifically, by encoding the features of the font in a specific Unicode to vectorize the same and selecting a replacement font based on the similarity in a feature space in which corresponding vectors exist, the sense of difference due to non-support of the font may be minimized.

The font server 10, which has received the above service usage information, may generate a customer unique number as identification information, store the generated client unique number along with the service usage information, and obtain and store web fonts based on the service usage information (S103). Specifically, the font server 10 may obtain a web font by searching for a font list previously stored in the font server 10 based on the font list to be used by the web server 20 in the service usage information.

If there is no font list to be used by the web server 20 in the pre-stored font list, the font server 10 may request a source font from the source font server 12, receive an encrypted source font, decode and store the corresponding source font, and obtain and store a web font using the corresponding source font.

In addition, the font server 10 may generate and store a web font module dedicated to the web server 20 based on the obtained web font (S104). Here, the web font module may be a JavaScript (JS)-based program designed to collect texts on web pages of a website for each font to generate cascading style sheet (CSS) information and add the CSS information to the website information.

In addition, when service usage information includes replacement font information, the font server 10 may generate and web font module to which the replacement font information is applied.

In addition, the font server 10 may generate and store user authentication information for user authentication based on the received service usage information (S105). Specifically, the font server 10 may generate and store user authentication information based on information that may identify users in the service usage information. For example, the user authentication information may include a customer identification number, a customer name, an application domain, a test IP, etc.

Next, the font server 10 may generate an HTML tag for executing the generated web font module (S106) and provide the generated HTML tag to the web server 20 (S107).

For example, the font server 10 may generate HTML tags for executing a web font module as shown in FIG. 5 and provide the HTML tags to the web server 20.

Then, the web server 20, which has received the HTML tag from the font server 10, may use the web font service by applying the received HTML tag to its website information (S108). Specifically, the web server 20 may use the web font service by inserting HTML tags into HTML documents within the website information.

According to the present invention, by inserting a short HTML tag into an HTML document, customers may easily apply the font they want to their website. In other words, according to the present invention, convenience of use for users who use paid fonts may be improved.

In addition, in the present invention, by using the web font module to which the replacement font information is applied, customers may freely mix and use multiple fonts without changing the HTML code of the website.

In addition, in the present invention, by using the web font module to which replacement font information is applied, limitations in the use of existing web fonts, which were limited in use due to glyphs not provided in a specific font, may be overcome.

Meanwhile, when changing the font list to be used, the web server 20 may request the font server 10 to change the font list and receive and use the web font module to which the changed font list is applied.

In this manner, customers using the font service may easily change the font applied to the website by applying the web font module to which the changed font list is applied to the website.

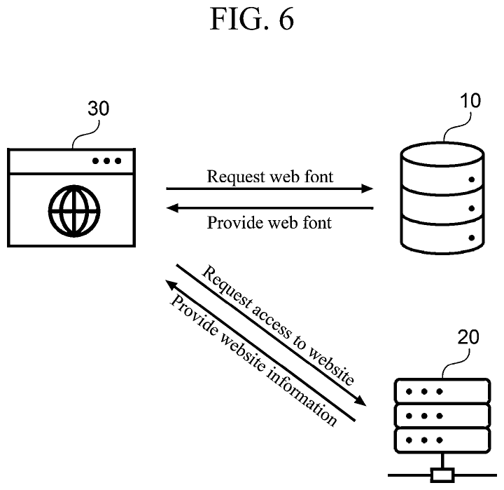

Next, a method for the font service system to provide a web font service to a client will be described with reference to FIG. 6.

FIG. 6 is a conceptual diagram illustrating a web font service method according to an embodiment of the present invention.

Referring to FIG. 6, when the client 30 requests access to a website from the web server 20, the web server 20 may provide website information corresponding to the website to the client 30.

Then, the client 30 may request a web font from the font server 10 based on the website information, receive the web font, and perform rendering based on the received web font to display text in the web page of the website.

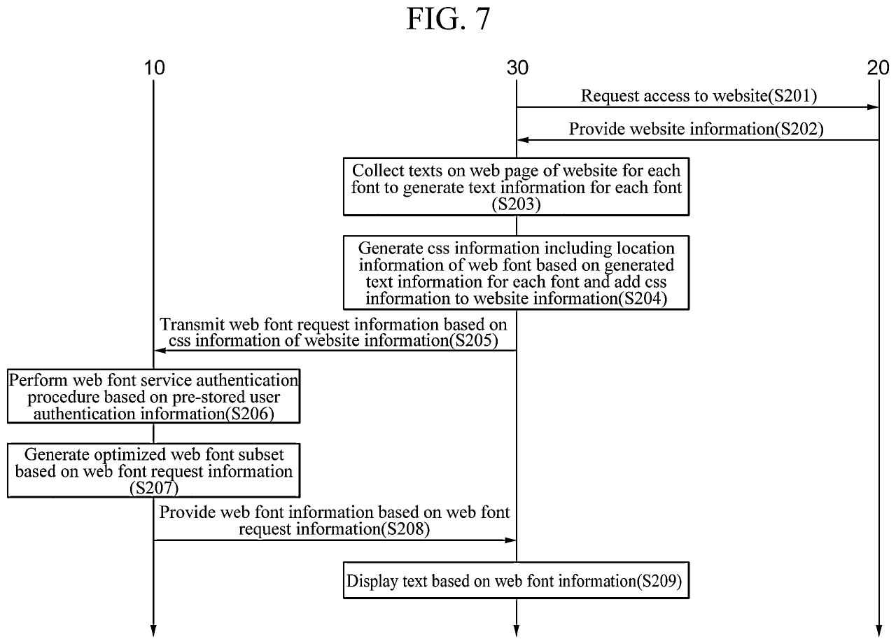

The web font service method will be described in more detail with reference to FIG. 7.

FIG. 7 is a timing diagram illustrating a web font service method according to an embodiment of the present invention.

Referring to FIG. 7, the client 30 may request the web server 20 to access a website (S201). Specifically, the client 30 may request the web server 20 to access a website through a URL of the website.

Next, the web server 20, which has received the request to access the website, may provide website information of the website including an HTML tag for executing the web font module to the client 30 (S202). Here, website information may be data required for rendering the website and may refer to an HTML document including contents, such as images and text.

Also, when the client 30 renders a web page, the web font module may be executed through the HTML tag in the website information, and the executed web font module may collect texts in the web page of the website for each font to generate text information for each font (S203). Here, the text information for each font may refer to data that organizes the minimum text required to render a website for each font.

Specifically, in the operation (S203) of generating text information, texts may be collected for each font in the web pages of the website, duplicate text may be removed from the collected texts, and de-identification may be performed by sorting the texts in Unicode order.

In addition, in the operation (S203) of generating text information, if the length of a text among the texts collected for each font in the web page of the website exceeds a predetermined length, the corresponding text may be divided into a predetermined length and text information for each font may be generated. In other words, by dividing text sorted in code order into unit lengths, responsiveness may be increased and additional de-identification effects may be achieved. In addition, the unit length for dividing text may be variably determined depending on a font type of the text, a total number of fonts to be used, and currently available resources of the font server 10. For example, if the currently available resources are small, the predetermined length may be determined to be short.

In addition, in the operation (S203) of generating text information, whether a replacement font is necessary may be determined. Specifically, in the operation (S203) of generating text information, the presence or absence of text corresponding to the replacement font among the texts collected for each font within the web page of the website may be determined based on the replacement font information.

For example, if there is text corresponding to the unicode range of a letter to be replaced among the collected texts, the web font module may determine that a replacement font is necessary. As described above, in the present embodiment, by removing duplicate text and sorting the texts in Unicode order, elements with literal meaning included in the texts may be de-identified and an application range of the replacement font may be more efficiently determined according to the sort order.

Therefore, in the operation (S203) of generating text information, when text corresponding to the replacement font is included in the collected texts, text information for each font may be generated by distinguishing between text corresponding to the replacement font and text not corresponding to the replacement font.

For example, in the operation (S203) of generating text information, among the collected texts, the text corresponding to the replacement font may be distinguished from the other text to remove a duplicate text, de-identification may be performed, and the text having a length exceeding a predetermined length may be divided into a predetermined length to generate text information for each font.

Next, the executed web font module may generate CSS (cascading style sheets) information including location information of a web font based on the generated text information for each font and add the generated CSS information to the website information (S204). Here, the CSS information is a style sheet that stores the overall style of a web document and may include information on a text font type, a font size, a font style, a font thickness, etc., as well as text information for each font.

In addition, the client 30 may transmit web font request information from the font server 10 based on CSS information in the website information (S205). Here, the web font request information may include data on the requested web font and various data required for an authentication procedure to use the web font service. For example, web font request information may include CSS information and user authentication information. Here, the user authentication information may be obtained from the web server 20.

Next, the font server 10 may perform a web font service authentication procedure using the web font request information received from the client 30 and the previously stored user authentication information (S206). Specifically, the font server 10 may determine whether the request has normally passed through the web server 20 of a customer's company by comparing the user authentication information in the web font request information with pre-stored user authentication information.

If it is determined that it is an abnormal access, the font server 10 may transmit an error response to the corresponding client 30 and provide the fact of an abnormal access to the corresponding web server 20. Here, the abnormal access is a web font request that does not go through the web server 20 of the customer's company and may include, for example, a case in which an ordinary user hijacks the URL, which is requested from a web browser to the font server 10 for the purpose of acquiring a web font file, directly requires the URL from the font server 10.

In other words, the present invention may prevent a font design of a paid font from being leaked by rejecting a web font file request from a domain or IP that has not been registered in advance through the aforementioned authentication process.

In addition, if it is determined to be a normal font request through the service authentication process, the font server 10 may generate an optimized web font subset based on the web font request information (S207). Here, the web font subset may refer to a font file with a reduced number of letters to improve dynamic load performance.

Specifically, the font server 10 may generate a web font subset by performing font subsetting based on text information in the web font request information and pre-stored web fonts.

In addition, the font server 10 may store the generated web font subset for a predetermined period of time. Here, the predetermined period may be variably determined depending on the size and frequency of use of the web font subset. For example, if the size of the corresponding web font subset is large or frequently used, the font server 10 may increase the predetermined period, and if used infrequently, the font server 10 may shorten the predetermined period.

Next, the font server 10 may transmit web font information to the client 30 based on the web font request information (S208). Here, the web font information is data including web font subsets generated based on text information in the web font fairy information, and may also include a replacement font subset depending on whether a replacement font is included.

If the same web font request is received from the client 30, the font server 10 may directly transmit web font information to the client 30 based on the previously generated and stored web font subset.

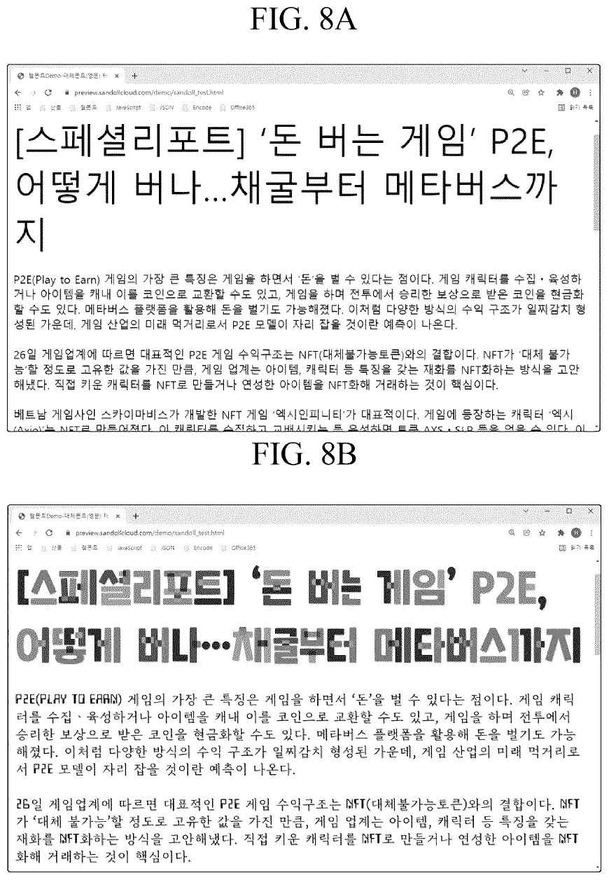

Also, the client 30 may display text by rendering a web page in the website based on the web font information provided from the font server 10 (S209). For example, text on a web page within a website may be displayed as shown in FIG. 8.

Specifically, (a) of FIG. 8 is an example of a web page screen within a website before a web font is applied, and (b) is an example of a web page screen within a website after a web font is applied.

In addition, in (b) of FIG. 8, a replacement font function is applied so that the text in a title area is displayed by replacing English and numbers with a purple font, and the text in a body area is displayed by replacing English and numbers with a font of a different shape.

According to the present invention described above, by using the web font module that collects text on a website by font to generate text information, generates CSS information based on the text information, and inserts the CSS information into an HTML document, time consumption due to the use of web fonts in rendering a web page rendering may be minimized.

In addition, the capacity of web font may be reduced by using an optimized web font subset when providing web font information.

In addition, by reducing the capacity of web fonts, a download time of the web fonts may be shortened and network traffic and costs may be reduced.

In addition, in the present invention, by using the web font module to which a replacement font is applied, missing glyphs of a specific font may be easily replaced or mixed with different fonts to make a specific letter stand out.

Meanwhile, the web font service described above is not limited to web fonts provided on websites and may be applied to various fields of displaying text. For example, the web font service described above may also be applied to interactive applications, such as messengers.

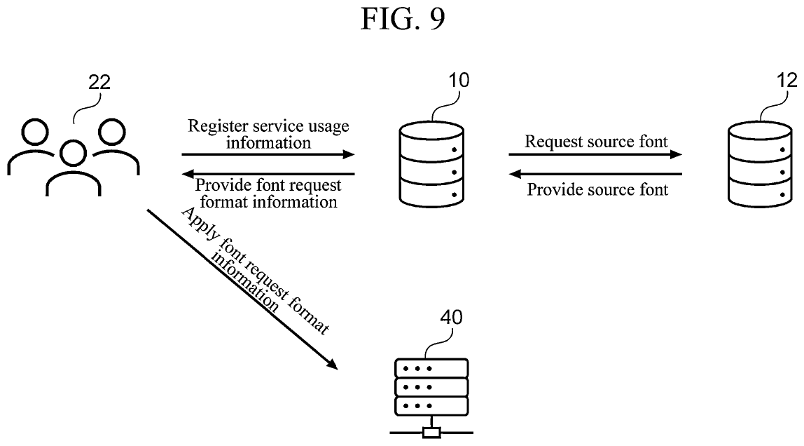

Hereinafter, a service usage information registration process for using an application-based font service will be described with reference to FIG. 9.

FIG. 9 is a conceptual diagram illustrating a font service usage information registration process according to another embodiment of the present invention.

Referring to FIG. 9, the customer 22 who purchased a font to be applied to an application may register information necessary for using the font in the font server 10, and the font server 10 may request a source font from the source font server 12 and receive the source font from the source font server 12.

Then, the font server 10 may generate font request format information and provide the generated font request form information to the customer 22, and the customer 22 may use the font service by applying the font request information to an account of an application operation server 40.

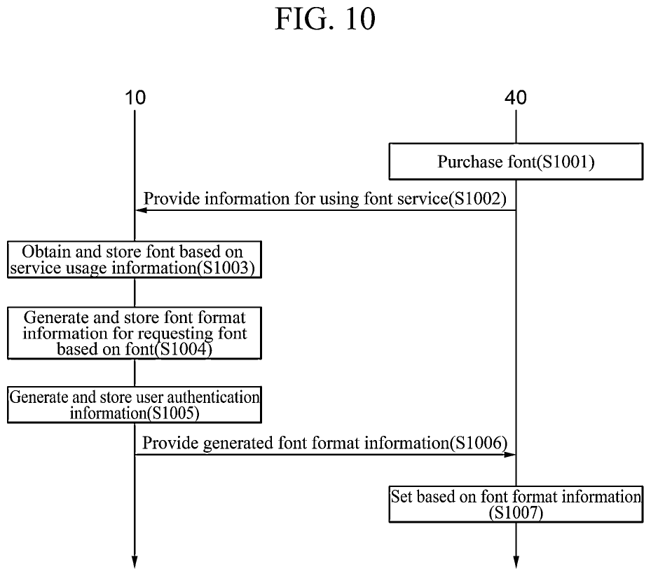

This will be described in more detail with reference to FIG. 10.

FIG. 10 is a timing diagram illustrating a service usage information registration process according to another embodiment of the present invention.

Referring to FIG. 10, the application operation server 40 may provide a service module, such as font purchase, and the customer 22 may purchase a font through the application operation server 40. Here, the application operation server 40 is a server that services an interactive application, and the customer 22 may request a font service through an interface provided by the application operation server 40.

Thus, a processing process of the application operation server 4 that performs a request of the customer 22 according to the interface will be described.

First, the customer 22 may purchase a font provided by the font server 10 through the application operation server 40 (S1001). Next, the application operation server 40 may provide service usage information for using the font service to the font server 10 (S1002).

In addition, the font server 10 may receive a source font from the source font server 12 upon request based on the received service usage information, and obtain and store the font based on the source font (S1003).

In addition, the font server 10 may generate and store user authentication information (S1004).

In addition, the font server 10 may generate and store font format information for requesting a font based on the obtained font (S1005). Here, the font format information may include information on a font type, a font size, a font style, a font thickness, etc.

Next, the font server 10 may provide the generated font format information to the application operation server 40 (S1006).

In addition, the application operation server 40 may provide a font service by setting a font based on font format information (S1007).

Meanwhile, operations S1001 to S1007 described above are performed in the same manner as the web font service registration process in FIG. 3, and thus, detailed descriptions are omitted.

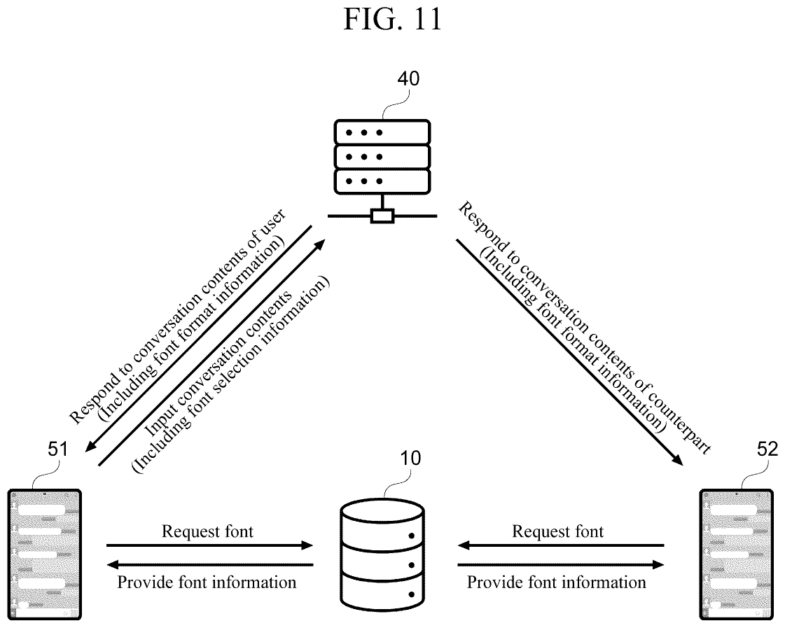

Next, a method of providing an application-based font service will be described with reference to FIG. 11.

FIG. 11 is a conceptual diagram illustrating a method of providing a font service according to another embodiment of the present invention.

Referring to FIG. 11, when a first client 51 using an application selects a font to use for chatting through a chat application and then inputs conversation contents, the application operation server 40 may transmit font format information along with the corresponding conversation contents to each of the first client 51 and a second client 52.

The first client 51 and the second client 52 may request a font from the font server 10 based on font format information, receive font information, and then display text in the application based on the font information. Here, the first client 51 and the second client 52 are terminals of users who use the corresponding application and may refer to smartphones, tablets, PCs, etc.

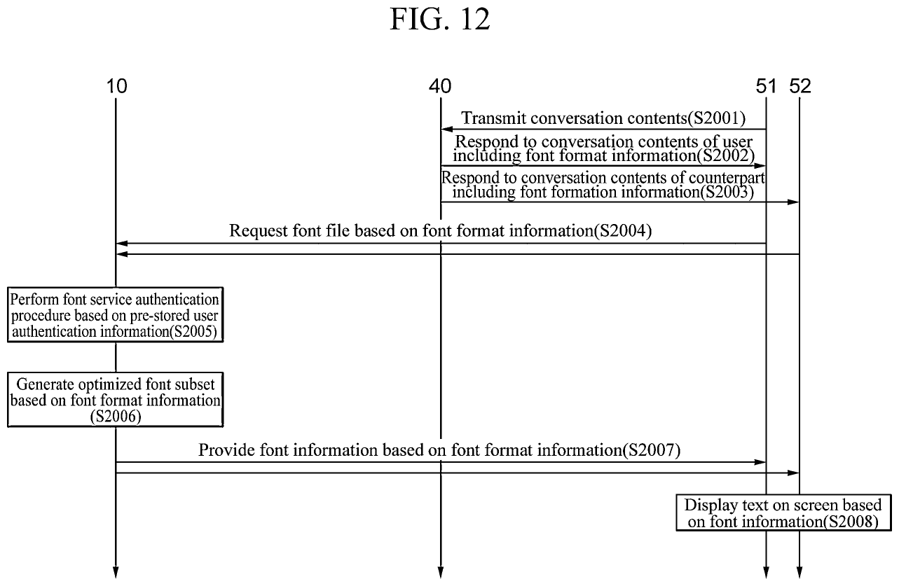

In relation to this, a method of providing an application-based font service will be described in more detail with reference to FIG. 12.

FIG. 12 is a timing diagram illustrating a method of providing a font service according to another embodiment of the present invention.

Referring to FIG. 12, the first client 51 may select a font to be used through the application, input conversation contents, and transmit the same to the application operation server 40 (S2001). At this time, the conversation contents and font selection information input to the application operation server 40 may be transmitted together.

Next, the application operation server 40 may select font format information based on the font selection information and provide the conversation contents of the user including the font format information to the first client 51 (S2002) and conversation contents of a counterpart including font format information to the second client 52 (S2003).

Then, the first client 51 and the second client 52 may request a font file from the font server 10 based on the font format information (S2004).

Next, the font server 10 may perform a font service authentication procedure based on pre-stored user authentication information (S2005).

In addition, the font server 10 may generate and store an optimized font subset based on the font format information (S2006).

Thereafter, the font server 10 may provide font information based on the font format information.

Specifically, the font server 10 may provide font information based on the generated font subset.

Then, upon receiving the font information, the first client 51 and the second client 52 may display text on the screen within the chatting application based on the font information (S2008).

Meanwhile, the operations S2001 to S2008 described above are performed in the same manner as each corresponding operation of the web font service method in FIG. 7, so detailed descriptions are omitted.

According to the present invention, it is possible to generate efficient and de-identified text information by collecting text on a website by font and to reduce network traffic and costs.

In addition, the present invention may provide readable information to users by using the web font module with the replacement font applied.

Various embodiments described herein may be implemented in, for example, a computer-readable recording medium or similar devices using software, hardware, or a combination thereof.

According to a hardware implementation, the exemplary embodiments described herein may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units for performing other functions. In some cases, the exemplary embodiments described in the present specification may be implemented by a control module itself.

According to a software implementation, the exemplary embodiments, such as procedures and functions described in the present specification may be implemented as separate software modules. Each of the software modules may perform one or more functions and operations described in the present specification. Software code may be implemented in software applications written in a suitable programming language. The software code may be stored in a memory module and may be executed by the control module.

The above description is merely illustrative of the technical idea of the present invention, and various modifications, changes, and substitutions may be made by those skilled in the art without departing from the essential characteristics of the present invention.

Accordingly, the exemplary embodiments disclosed in the present invention and the accompanying drawings are not intended to limit the technical idea of the present invention but to describe the present invention, and the scope of the technical idea of the present invention is not limited by the exemplary embodiments and the accompanying drawings. The protection scope of the present invention should be interpreted by the following claims, and all technical ideas within the equivalent scope should be interpreted as being included in the scope of the present invention.

1. A web font service method of a font server, the web font service method comprising:
receiving web font request information from a client provided with website information including an HTML tag for executing a web font module; and
transmitting web font information to the client based on the web font request information,
wherein the web font module generates cascading style sheet (CSS) information including location information of a web font based on text information obtained by collecting texts on a web page of the website for each font and adds the CSS information to the website information, and
the client transmits web font request information generated by recognizing the generated CSS information to a font server.

2. The web font service method of claim 1, further comprising:
performing, by the font server, a web font service authentication procedure using the received web font request information and pre-stored user authentication information.

3. The web font service method of claim 1, wherein
the web font module removes a duplicate text among the collected texts and sorts the texts in Unicode order to generate de-identified text information for each font.

4. The web font service method of claim 3, wherein,
when a length of a text among the sorted texts exceeds a predetermined length, the web font module divides the corresponding text to generate text information for each unit font.

5. The web font service method of claim 1, wherein:
the web font module determines whether there is a text corresponding to a replacement font among the collected texts, and when text corresponding to the replacement font is included, the web font module separates the text corresponding to the replacement font to generate text information for each font.

6. The web font service method of claim 1, further comprising:
receiving, by the font server, service usage information for using the web font service from the user;
obtaining a web font based on the service usage information;
generating a web font module dedicated to the user based on the obtained web font; and
generating an HTML tag for executing the web font module and providing the HTML tag to the user.

7. The web font service method of claim 1, wherein the transmitting of the web font information to the client comprising,
generating a font subset based on the web font request information, and
transmitting web font information including the generated font subset to the client.

8. A web font service method of a web server, the web font service method comprising:
receiving a website access request from a client; and
providing website information including an HTML tag for executing a web font module to the client,
wherein the web font module generates cascading style sheet (CSS) information including location information of a web font based on text information obtained by collecting texts on a web page of a website for each font and adds the CSS information to the website information, and
the client transmits web font request information generated by recognizing the generated CSS information to a font server.

9. The web font service method of claim 8, wherein
the web font module removes a duplicate text among the collected texts and sorts the texts in Unicode order to generate de-identified text information for each font.

10. The web font service method of claim 9, wherein, when a length of a text among the sorted texts exceeds a predetermined length, the web font module divides the corresponding text to generate text information for each unit font.

11. The web font service method of claim 8, wherein the web font module determines whether there is a text corresponding to a replacement font among the collected texts, and when text corresponding to the replacement font is included, the web font module separates the text corresponding to the replacement font to generate text information for each font.

12. A font service system of providing a web font service, the font service system comprising:
a client configured to access a website and request web font information necessary for the website;
a web server configured to provide website information to the client requesting access to the website; and
a font server configured to provide web font information to the client,
wherein,
when requesting access to a website, the web server provides website information including a HTML tag for executing a web font module to the client,
the web font module generates cascading style sheet (CSS) information including location information of a web font based on text information obtained by collecting texts on a web page of a website for each font and adds the CSS information to the website information, and
the client transmits web font request information generated by recognizing the generated CSS information to a font server, and
the font server generates web font information based on the web font request information and transmits the web font information to the client.

13. A computer-readable recording medium in which a program of performing the web font service method according to claim 1 is stored.
